(19) United States
(12) Patent Application Publication
(10) Pub. No.: US 2010/0115786 A1
(43) Pub. Date: May 13, 2010

(54) METHOD AND SYSTEM FOR DRYING A WATER CONTAINING SUBSTANCE

(76) Inventor: Gÿsbert Docters Van Leeuwen, Heythuysen (NL)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/513,072

(22) PCT Filed: Nov. 2, 2007
(86) PCT No.: PCT/EP2007/009524

§ 371 Date: Jan. 21, 2010

(30) Foreign Application Priority Data
Nov. 2, 2006 (GB) 0621789.7

(51) Int. Cl. F26B 7/00; F24J 2/04; F26B 3/02; F26B 19/00

(52) U.S. Cl. 34/381; 126/634; 34/513; 34/61; 34/69

(57) ABSTRACT

A method and system for drying a water containing substance, such as manure, into a single dry product, wherein an airflow is conditioned, in order for the airflow to be able to take up moisture, and wherein a substance/airflow interface is provided, in order to allow the air to take up moisture from the substance at the interface to thereby dry the substance, wherein the method comprises the steps of heating the airflow, separating the substance in a relatively solid fraction and a liquid, using the relatively solid fraction to create a first, static substance/airflow interface, using the liquid fraction to create a second, dynamic substance/airflow interface, guiding the airflow to the first substance/airflow interface to dry the relatively solid fraction of the water containing substance, and thereafter guiding the airflow to the second substance/airflow interface to pre-dry the liquid fraction of the water containing substance, mixing the pre-dried liquid fraction with water containing substance.

The present invention relates to a method and a system for drying a water containing substance, such as manure.

In recent years, pig farms are confronted with problems relating to odour, nuisance, dust generation and ammonia production. In order to operate a pig farm without running into problems relating to emission of the odour, dust and ammonia, the pig farm will need to invest in systems and processes to keep the emissions below a preferred limited level.

One of the further problems of operating a pig farm is the production of manure. A pig at a typical piggery will produce one to five cubic meters of manure per year. An important feature of the manure is the fact that the content of solids in this manure is very low (3 to 10%). Thus transporting of non-dried manure is very costly.

Because of the low amount of solids in the manure it requires relatively a large amount of energy and therefore money in order to remove water from the manure.

With respect to the challenges a modern pig farm has to overcome in order to operate profitably, it is an object of the present invention to provide a process for drying a water containing substance, such as manure, which could advantageously be used when operating a pig farm.

### SUMMARY OF THE INVENTION

In a first aspect, the invention relates to a method for drying a water containing substance, such as manure, into a single dry product, wherein an airflow is conditioned, in order for the airflow to be able to take up moisture, and wherein a substance/airflow interface is provided, in order to allow the air to take up moisture from the substance at the interface to thereby dry the substance, wherein the method comprises the steps of:
heating the airflow,
separating the substance in a relatively solid fraction and a liquid,
using the relatively solid fraction to create a first, static substance/airflow interface,
using the liquid fraction to create a second, dynamic substance/airflow interface,
guiding the airflow to the first substance/airflow interface to dry the relatively solid fraction of the water containing substance, and thereafter
guiding the airflow to the second substance/airflow interface to pre-dry the liquid fraction of the water containing substance,
mixing the pre-dried liquid fraction with water containing substance.

The method for drying a water containing substance, such as manure, according to the present invention, has as a basic principle, the use of the interface of a manure flow and an air flow in order to take up moisture from the manure into the air. In order for the air to be able to take up moisture from the manure, the air must be conditioned, more in particular the air must have a low relative humidity, in order to increase the drying capability of the air.

According to the present invention, the conditioned air flow is first used to further dry the relatively solid fraction of the water containing substance. Thereafter, the airflow which has already taken up a certain amount of water is used to pre-dry the liquid fraction of the water containing substance. After pre-drying this liquid fraction, the pre-died liquid fraction is mixed with water containing substance in order to increase the solid contents of the water containing substance.

According to the present invention the air flow is heated by means of low energy heat. In case the method is used for drying manure, this heat is, for instance, produced by the pigs themselves. It is possible to add additional energy in the form of residual energy from other processes or in the form of solar energy. After using the air for drying part of the manure, any residual heat available in the air flow is extracted from the air flow in order to be reused in a further stage of the drying process.

In order to increase the drying capability of the system, preferably further warm fluid, such as warm water, is used in order to heat up the air flow/manure interface by guiding the relatively warm fluid through and the manure through a heat exchanger, preferably in opposite direction, thereby indirectly heating the manure and guiding the heated manure and the air flow through a packing material, which then directly heats up the airflow and allows the airflow to take up moisture from the manure. Residual heat from the relatively warm fluid is stored in order to be reused in a further stage of the drying process.

According to the present invention, the manure is pre-dried in order to increase the solids content of the manure. Thereafter the relatively wet manure is mixed with dry manure to further increase the solids content and thereafter the concentrated manure is shaped into manure elements of a circular form, such as strings or pellets. These shaped manure elements are thereafter dried in order to obtain relatively dry manure particles.

According to a further aspect of the invention, the invention relates to a system for drying a water containing substance, such as manure, comprising a ventilator for producing an airflow, air heating means, for conditioning the airflow, a substance/airflow interface, provided with a reservoir for containing the water containing substance and adapted to allow the conditioned airflow to pass through the reservoir in order to allow the air to take up moisture from the substance, wherein the system comprises:
a separator for separating the water containing substance in a liquid fraction, essentially free of solid parts, and a relatively solid fraction,
a press for shaping the relatively solid fraction,
a first static substance/airflow interface, for drying the shaped relatively solid fraction of the water containing substance, and
a second dynamic substance/airflow interface, provided downstream from the first substance/airflow interface, to pre-dry the liquid fraction of the water containing substance.

The system for drying a substance according to the present invention can be used in combination with a solar heating system. Alternatively the system can use residual heat, for instance from another industrial process. It is possible to generate heat from combustion of (part of the) dried manure.

Preferred embodiments of the invention are described in the dependant claims.

Please note that in the present text, the wording “relatively solid fraction” and “liquid fraction” are used. The method and the system according to the present invention are typically advantageous when drying a water containing substance with a low solid content. In case the method and the system according to the present invention are used for drying manure, the liquid fraction has typically a solid content of about 4-5%. It is important that this fraction does not contain any contamination such as hairs, nails and other solid parts which may contaminate filters and similar apparatuses. The “relatively solid fraction” is still not more than a slurry with typically a solids content of 10 to 40%.

In the present text referenced is made to a substance/air flow interface. According to the present invention there is a direct contact between the water containing substance to be dried and the air flow used to realize the drying process. At the water/air flow interface measures are taken to increase the contact area between the water containing substance and the air flow. For the liquid fraction the increase of the surface area can be done by allowing the liquid fraction to flow under the influence of gravity in order to create a film of liquid fraction exposed to the air flow. In case of the relatively solid fraction the surface area is increased by shaping the solid fraction in elements which have for instance the form of strings or pallets

The present invention will be described below with reference to the accompanying drawings, in which:

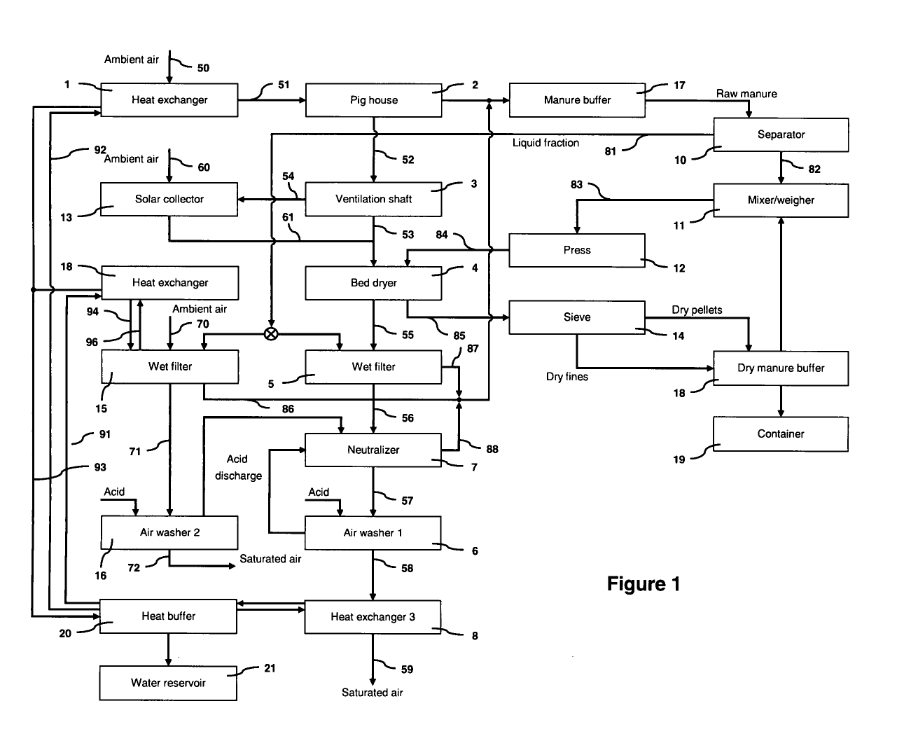

FIG. 1 shows a schematic overview of the process for drying a water containing substance, such as manure;

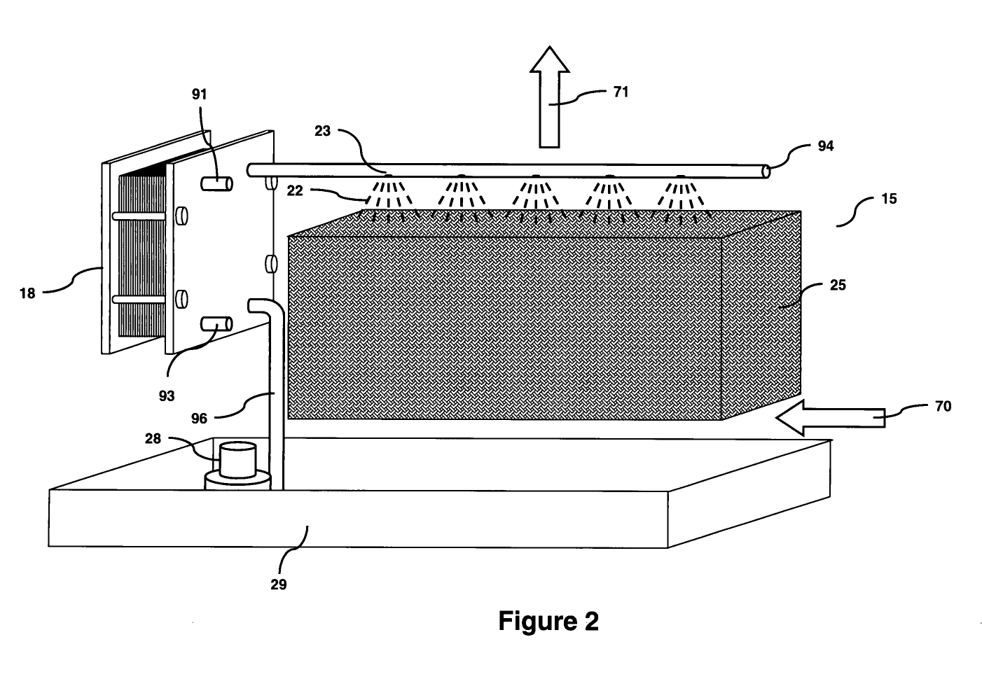

FIG. 2 shows a possible embodiment of a dust filter to be used in the process according to the present invention;

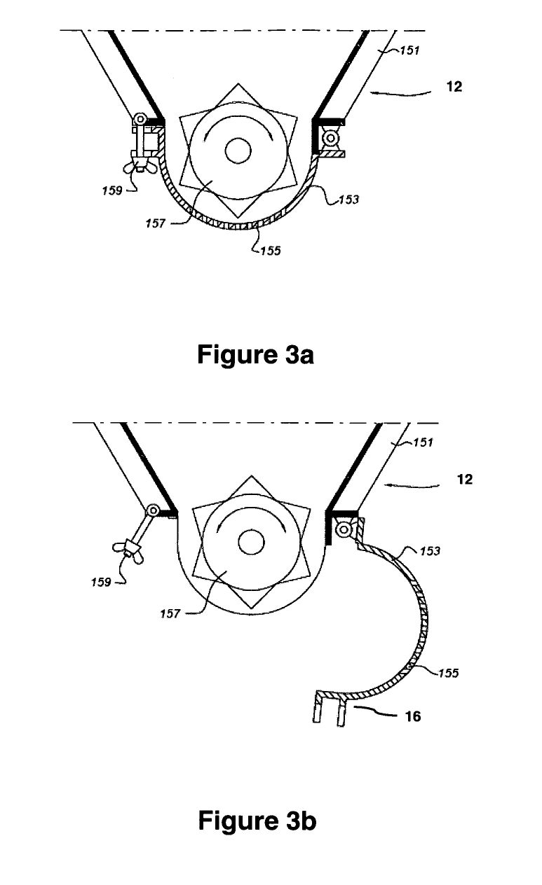

FIG. 3a shows a possible embodiment of a press to be used to shape manure into manure elements, such as pellets;

FIG. 3b shows the press of FIG. 3a where the lower side is opened;

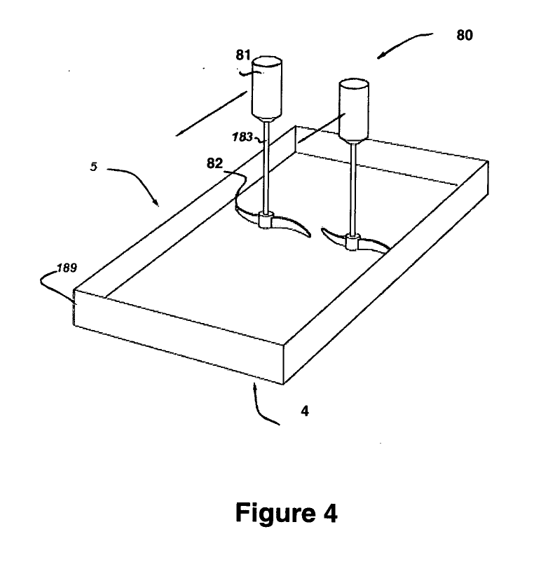

FIG. 4 shows a possible embodiment of a manure releasing device to be used to release dried manure from the bed dryer; and

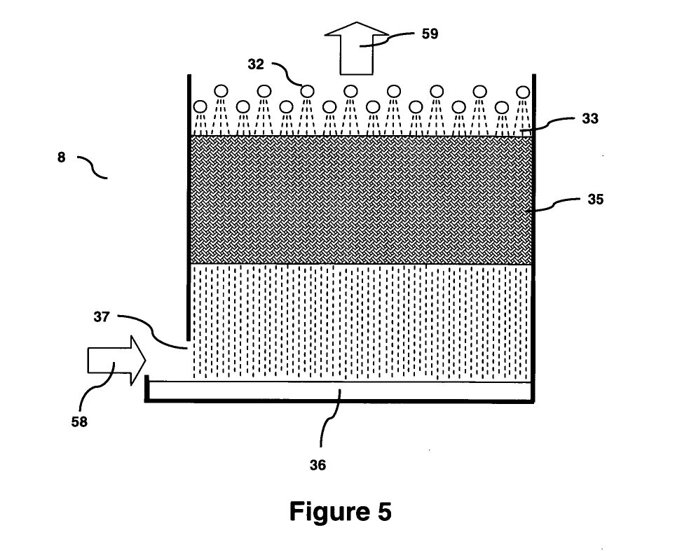

FIG. 5 shows a cooling tower, for recovering residual heat from the saturated air used for drying manure.

The main principle of the process and system according to the present invention is to create a contact surface between a quantity of a water containing substance and an airflow. This airflow is conditioned in order to improve the capability of the airflow to take up water from the water containing substance.

As an example, in the description below, reference is made to the use of the invention for drying manure. It has to be understood that the process, according to invention can also be used for other water containing products, such as sludge from water treatment or residual streams from fermentation processes or food processing.

With respect to the figures, the process and the system according to the present invention will be described. In part A, reference is made to the airflow through the process and the system.

In part B, the flow of manure in the process and the system is described.

Part A

FIG. 1 shows a schematic overview of the process for drying a water containing substance, such as manure. In a pig house 2 a number of animals is held. These animals produce a substantial amount of heat and humidity. The pig house 2 needs to be ventilated. Not only to provide the animals with fresh air, but also to control the temperature and the relative humidity in the pig house 2. Without this ventilation the temperature and relative humidity in the pig house 2 would rise to an undesirable level.

Ambient air is fed to the pig house 2 via the line 51. The air is introduced in the pig house 2 with a relatively low speed of typically 1-2 m/s.

In the pig house 2 the temperature of the incoming air will increase due to the heat produced by the animals. In the pig house 2 the air flow will also take up dust, ammonia and moisture. The air flow will leave the pig house 2 via line 52. When leaving the pig house 2 the air flow will be warmer and thus will have a lower relative humidity then the ambient air that was fed to the pig house 2. That means that the heat produced by the livestock in the pig house 2 is used as a source of ‘free’ energy to heat up the airflow.

The air flow leaving the pig house 2 via line 52 is able to take up moisture.

In order to be able to use the air flow in a drying process and in order to be able to expel the air flow after the drying process, the air has to be treated in that the dust particles and the ammonia have to be removed from the air flow, before expelling the airflow to the environment.

The process and the system, according to FIG. 1, comprise a bed dryer 4. This bed dryer 4 provides a container for receiving manure. A possible embodiment of the bed dryer 4 will be described with reference to FIGS. 3a, 3b and 4. A main principle of the bed dryer is on the one hand to be able to contain a water containing substance and on the other hand to allow an airflow to pass through the water containing substance, allowing direct contact between the water containing substance and the airflow.

According to FIG. 1, the airflow leaving the pig house 2 can be fed by means of a ventilation shaft 3 to the bed dryer 4 via line 53. Alternatively, it is possible to guide the airflow, or part of the airflow, via line 54 towards a solar collector 13. For a manure dryer, it is typically advantageous to position such a solar collector 13 on the roof of the pig house 2. The roof of the pig house provides a relatively large surface area for receiving solar energy and for transferring this received solar energy in case the pig house is provided with a gabled roof, the two halfs of the roof will have a different orientation with respect to the incoming sunrays. This means that the air temperature on the one half of the roof will be different from the other half of the roof. The airflow through the solar collector 13 is controlled, using temperature sensors, in order to pass the airflow through the part of the solar collector, which has a preferred orientation with respect to the sun.

This solar collector 13 is used to further heat up the air flow before guiding the air flow via line 61 to the bed dryer 4. It is possible to introduce additional air to the drying process by guiding fresh air via lines 60 and 61 via the solar collector to the bed dryer 4. The possibility to feed additional air to the drying process is important, since the amount of air leaving the pig house 2 is limited by the amount of air necessary to regulate the conditions in the pig house. Via the line 60 additional air can be fed to the bed dryer 4 in order to optimize the drying process without the need of influencing the conditions in the pig house 2.

The lines 53, 54, 60 and 61 are all provided with valves in order to control the air flow towards the bed dryer 4.

In case the ambient air is relatively cold e.g. below 10° C., it may be preheated in a first heat exchanger 1. This first heat exchanger 1 is connected with the ventilation exhaust of the system according to FIG. 1. This ventilation exhaust is provided with a third heat exchanger 8. Using the third heat exchanger 8, residual heat from the air expelled from the system towards the environment is recovered.

By pre-heating the relatively cool ambient air entering the pig house 2, the temperature of the air in the pig house 2 will be increased and the relative humidity will be decreased. By increasing the temperature of the air entering the pig house 2 and decreasing the relative humidity, automatically the temperature of the air leaving the pig house 2 will be increased and the relative humidity will be decreased. The bed dryer 4 and the dust filter 5, the functioning whereof is described below, will be more efficient when the air leaving the pig house 2 has an increased temperature, since those devices can operate using air with an increased temperature and with a lower relative humidity. A higher temperature of the air in the pig house 2 and a lower relative humidity is also beneficial for the well being of the animals which are held there. Another effect of pre-heating the ambient air entering the pig house 2 is the fact that the process according to FIG. 1 can be operated with an increased airflow. The reason for this is that the relatively warm air entering the pig house 2 will more quickly reach the necessary temperature level in order for the air to be efficiently used in the bed dryer 4 and the dust filter 5. The heat used for pre-heating the ambient air is recovered by using the third heat exchanger 8. This third heat exchanger 8 is, via a heat buffer 20, connected to the first heat exchanger 1. If required this heat may be upgraded, by means of a heat pump. The use of residual heat has the additional advantage that no fossil fuel or gas is required for heating the pig house.

The bed dryer 4 comprises a reservoir or tray for receiving the manure. This reservoir is provided with a bottom provided with openings or perforations in order to allow the airflow to enter the reservoir through this bottom and to flow upwards. The direct contact between the air flow and the manure will allow the air to take up moisture from the manure and to thereby dry the manure.

A possible embodiment of the bed dryer will be described below with reference to the FIGS. 3, 4 and 5.

Because of the contact of the air flow with the manure in the bed dryer 4, the relative humidity of the air will further increase. The air flow will be partially saturated. The contact with the manure will have removed at least part of the particles from the air flow. However, the air flow leaving the bed dryer 4 via line 55 will still contain ammonia and dust particles. These elements will have to be removed from the air flow before the air can be expelled from the system. The air flow is therefore fed to a dust filter 5.

In the dust filter 5 the air flow is brought in direct contact with the liquid manure fraction. As will be explained below, in the process and system according to the present invention, the manure produced by the animals is separated into a liquid manure fraction and a relatively solid manure fraction, using a separator. The separator is indicated by the reference number 10 in FIG. 1. The relatively solid manure fraction contains all solid manure elements and other solid parts such as, for instance, animals nails and hairs. Those solid parts could block filters, lines and other parts of the system. The liquid fraction however, doesn't contain any of those contaminations and can be transported in the system using normal pipes, pumps, lines and filters. The liquid manure fraction which is fed to the dust filter 5 is relatively wet. Because of the direct contact between this liquid manure fraction and the air flow, two processes will take place at the same time. The air flow will take up moisture from the liquid manure and thereby lower the water content of the liquid manure. The liquid manure fraction will take up the dust particles from the air flow. For optimum contact between the air flow and the manure, the air flow may be passed through the dust filter from the bottom up (counter flow) or from one side to the opposite side (cross flow).

It has to be noted that, in the process and system according to FIG. 1, a first wet filter 5 and a second wet filter 15 are indicated. The functioning of both wet filters is similar in that part of the liquid manure fraction is brought into contact with the airflow in order to take up moisture from the liquid manure fraction. In order to obtain the exchange of moisture from the liquid manure fraction towards the airflow, the liquid manure fraction is pumped from the separator 10 using line 81, towards both the first wet filter 5 and the second wet filter 15. The first wet filter 5 and the second wet filter 15 use different parts of the airflow in the system. The airflow conducted towards the first wet filter 5 originates from the bed dryer 4 and is guided towards the first wet filter 5 by using line 56. For the second wet filter 15 ambient air is used. Below a possible embodiment of the second wet filter 2 is discussed with reference to FIG. 2. The embodiment of the first wet filter 5 will be similar, but several parts which need to be present in the second wet filter 15, can be omitted in the embodiment of the first wet filter 5.

A possible embodiment of the second wet filter 15 is shown in FIG. 2. The wet filter 15 comprises packing material with an open structure 25. The packing material 25 is positioned in order to allow liquid manure to travel, under the influence of gravity, from the upper level of the packing material towards the lower level as a liquid film. The liquid manure, (symbolically indicated by dotted lines 22), is sprayed over the exterior of the packing material 25 by means of nozzles 23 or is dripped onto the carrier material through holes in a circulation line, where the liquid manure is permanently circulated in order to prevent sedimentation of the liquid manure in the circulation line. These nozzles 23 are connected, by means of a recirculation line 94 (partly shown) to a second heat exchanger 18. A relatively warm fluid, such as water is introduced in the heat exchanger 18, through a line 91 in order to heat up the recirculation line. The heat exchanger is connected by means of a line 96 to a liquid collector 29 that is provided with a submerged pump 28 to pump the liquid manure from the liquid collector 29 to the heat exchanger 18. The collector 29 is connected, by means of a line 81 to the separator 10. The wet filter 15 is further provided with a line 70 to feed ambient air to the wet filter 15.

The liquid manure 22 trickles under the influence of gravity from the upper level towards the lower level of the packing material as a liquid film. In the opposite direction the air flow, originating from the line 70, is guided upwards through the wet filter 15. This relatively warm air flow is able to take up moisture from the liquid manure 22, thereby concentrating the liquid manure 22.

By means of the wet filter 15 the liquid manure 22 can be concentrated to have typically a solids content of 16%, when leaving the wet filter 15. At the same time, because of the presence of relatively wet manure 22, the wet filter 15 will function as a dynamic filter, able to remove the dust particles from the flow of air.

In an alternative embodiment the separation of the manure into a liquid fraction and a relatively solid fraction, and the subsequent pre-drying of the liquid fraction in the wet filter 5 are omitted. In this case fresh manure from the reservoir is mixed with a portion of manure that has been dried in the bed dryer 4. Similar as will be described in part B, the mixed manure, which has an increased dry solids content, is then shaped into strings or pellets and deposited on the bed dryer 4. Due to the permeability of the shaped manure, the thickness of the bed may be increased up to 30-50 cm, without increasing the flow resistance of the airflow, when passing through the bed, to unacceptable levels. The continuous deposition of relatively wet manure strings or pellets on the bed provides a gradient that will allow the airflow to become saturated, when passing through the bed from the bottom—containing relatively dry pellets—to the top, while dust will be captured in the top layer of the bed.

In FIG. 2, the second heat exchanger 18, which is used to heat up the liquid manure 22, is fed via a heat buffer 20 with warm water through a line 91, which is connected to a third heat exchanger 8. The functioning of this heat exchanger 8 will be described below with reference to FIG. 5.

The first wet filter 5 will operate similar to the second wet filter 15 as described above. Contrary to the second wet filter 15, the first wet filter 5 is fed by line 55 which transports air coming out of the bed dryer 4 towards the wet filter. That means that the first wet filter 5 is provided with relatively warm air which has originally been warmed up in the pig house 2 and which has already been used for the first heat exchange with manure present in the bed dryer 4. In the first wet filter 5, residual heat from the airflow can be used to take up moisture from the liquid manure fraction in the first wet filter 5. In theory, it would be possible to connect the first wet filter 5 to an additional heat exchanger in order to pre-heat the liquid manure fraction similar to the heat exchanger 18 used in the second wet filter 15 of FIG. 2. In practice, such an additional heat exchanger may be emitted for the first wet filter 5.

It is noted that it is possible to provide manure to the first wet filter 5 and the second wet filter 15, either with a constant feed of manure or, alternatively to provide liquid manure periodically to the wet filters 5, 15.

Returning to FIG. 1, the air flow leaving the dust filter via line 56 will have taken up moisture inside the wet filter 5. The air flow will no longer contain dust particles. However, the air flow will still contain ammonia. Therefore the airflow is guided towards an air washer 6. In the air washer 6 the air flow is forced through a packing material similar to what has been described with respect to the dust filter 5. Fluid containing sulphuric acid is sprayed over the packing material. The ammonia (NH₃) in the airflow will be bound by the sulphuric acid (H₂SO₄) in the fluid trickling down the packing material, to form ammonium sulphate ((NH₄)₂SO₄). This ammonium sulphate will be dissolved in the fluid used in the air washer. Once this fluid is saturated with ammonium sulphate, the fluid can be removed from the air washer and may be placed in a neutralizer 7 for neutralizing any residual sulphuric acid in the fluid. The neutralizer 7 is very similar to the air washer and is placed upstream of the air washer 6, where the air flow is forced through a packing material containing the fluid. The ammonia (NH₃) in the airflow will neutralize the residual sulphuric acid (H₂SO₄) in the fluid, to form further ammonium sulphate. Once the fluid is neutralized, the fluid can be removed from the neutralizer and be used as a fertilizer. Alternatively, the fluid can be added to the manure buffer 17 in order to be dried as an integral part of the manure.

The air washer 6 may be connected to a biological filter (not shown). This optional biological filter is used to remove odour from the airflow. The airflow contains odour in the form of volatile fatty acids. The biological filter contains micro-organisms capable of decomposing the fatty acids.

The air flow leaving the air washer 6 will flow via line 58 towards the heat exchanger 8. The air leaving the air washer 6 will be saturated. The heat exchanger extracts residual heat from the air flow, consisting of the heat content of the air flow and the heat of condensation of the water vapour in the air flow, before expelling the air flow via the line 59 to the environment. Since the air flow will not contain dust particles, the heat exchanger 8 will not be fouled and eventually blocked by dust particles sticking to the heat exchanger.

In the heat exchanger 8 a water circuit is used to take up heat from the air flow through the heat exchanger 8. The so heated water is fed to another heat exchanger 18 through a line 91, where it heats up the liquid manure 22, which is sprayed over dust filter 15. A separate part of the water from heat exchanger 8 is fed through the line 92 to the heat exchanger 1, where it is used to heat up ambient air added to the pig house via line 50 (partly shown).

The water circuit in the heat exchanger 8 is connected to a heat buffer 20. Any excess heat produced in the solar collector 13 and not used directly in the drying process can be stored in this heat buffer 20. By means of the solar collector 13 heat can be produced and stored during the daytime. This heat can be used during the nighttime to provide heat to the heat exchanger 18, which then heats up the liquid manure 22 that is sprayed over dust filter 15. In this way moisture can be evaporated during the nighttime using solar heat collected during the daytime.

Due to the extraction of heat from the air flow 58 in the heat exchanger 8 part of the moisture in the saturated air flow will condense, producing water. This condensed water will be collected in water reservoir 21 and can be used for irrigation purposes or as process water.

Part B

Above the process according to the invention is described with reference to the flow of air through the process. Below the flow of the water containing substance, such as manure through the process of FIG. 1 will be explained in detail.

The manure produced by the livestock is collected in a manure reservoir 17. In order to process the manure, the manure is in a first step guided towards a separator 10. In this separator the manure is separated in a liquid fraction, with typically a solids content of 4-5%, and a relatively solid fraction with a solids content of typically 10-15%.

The liquid fraction is fed via line 81 towards the dust filter 5. In the dust filter 5 the manure is concentrated as described above. When leaving the dust filter 5, the manure is fed back via line 87 towards the manure reservoir 17. This allows foam that will be formed in the dust filter to break down. The recycled concentrated manure may enhance the separation process above by acting as ‘glue’ for the contaminations in the fresh manure. It is possible to add to this concentrated manure any saturated liquid from the neutralizer 7, via line 88.

The relatively solid fraction is fed via line 82 towards a mixer 11. The relatively solid fraction contains the contaminations of the manure such as hairs and nails. These contaminations are likely to block lines in the dust filter 5 and succeeding elements of the process and should therefore be extracted from the liquid fraction of the manure.

In the mixer 11 the solids content of the manure is increased by mixing the relatively solid fraction with dust particles and dried manure harvested from the bed dryer 4.

The relatively solid fraction is transported via line 83 towards a press or shredder 12. In the press 12 the relatively solid fraction of the manure is, by means of a mechanical operation, pressed into manure elements of similar diameter. The manure elements may have the form of strings or pellets. The object of forming the manure into manure elements of similar diameter is to be able to deposit the manure elements in the bed dryer 4, thereby forming a relatively open and uniform manure bed, which allows the passing of an airflow. In other words: the object is providing a uniform porous bed with a large contact area that facilitates contact between the airflow and the manure, resulting in a uniform drying process.

In order to be able to press the concentrated manure into strings or pellets, the manure should have a minimal solids content of about 25%.

The manure elements are fed via line 84 towards the bed dryer 4. A possible embodiment of the bed dryer will be discussed below, with reference to FIGS. 3, 4 and 5.

The manure elements that have been dried in the bed dryer will be removed from the bed dryer 4 via line 85. The dried manure will be transported via an in-line sieve 14 towards a buffer 18 for temporary storage. The in-line sieve 14 will separate manure dust particles from larger dried manure elements. The larger dried manure elements can be removed from the buffer and can be stored in a container 19. These dried elements provide the end product of the drying process. The end product can either be used as a fertilizer or can be used as a fuel.

The dust particles collected in the buffer 18 can be fed towards the mixer 11 and can be used to increase the solids content of the manure in the mixer. If required, part of the larger dried manure elements can be used for the same purpose.

FIG. 3a shows a schematic cross section of a possible embodiment of the press 12. The press is placed on a trolley, (not shown) provided with wheels (not shown). The trolley is adapted to run on the edges of the walls of the bed dryer 4. The width of the press 12 matches the width of the bed dryer 4.

The press 12 has a recipient 151 with essentially the form of a V (partly shown), with two inclined walls. At the bottom, the recipient is provided with a plate 153 that can be closed with a shackle. Such a plate is not absolutely required, yet is very practical in use. The plate can be elongated and semicircular as shown in FIGS. 3a and 3b. The entire length of the plate 153 is provided with apertures or perforations 155 that are preferably provided at equal distance. In the semicircular plate an elongated cog wheel 157 is provided. The cog wheel 157 is adapted to rotate freely around a central rotation shaft, both in a first direction of rotation, for example to the left, as in a second direction of rotation, for example to the right. Free rotation means that the plate 153 is not touched during rotation. It is well known to the skilled person how the rotation shaft of the cog wheel 157 can be driven through gears with drive means such as an electric motor drive. Manure is inserted in the recipient 151 and forced through the perforations 155 in the semicircular plate 153 by means of rotation of the cog wheel 157. The cog wheel 157 compresses the manure. The combination of the cog wheel 157 and the perforations 155 will form the manure into cylindrically shaped manure strings. Under the influence of gravity the strings will break up to form manure pellets. The cog wheel 157 is able to rotate in two opposite directions in order to release any contamination, like hairs, captured in the perforations 155.

FIG. 3b shows a schematic cross section of the press 12 of FIG. 3a where the plate 153 is opened by releasing the nut 159. In the opened position contaminations such as stones, nails etc. that may block the cog wheel 157 can be removed easily. Furthermore maintenance to the cog wheel 157 is facilitated. After removing contaminations or maintenance work, the plate is closed again by placing the nut 159 over the shackle 160 and fastening the nut 159.

The trolley is provided with wheels and a motor drive to move the trolley over the side walls of the bed dryer 4, from one end to the other. The trolley is moved while depositing the manure elements in the bed dryer 4, allowing the trolley to evenly distribute the manure over the entire length and width of the manure bed 4, without additional mechanical means for distribution, thus limiting the risk of smearing the relatively soft manure strings and pellets and clogging the bed dryer.

As described above, the manure in the dryer bed 4 is dried by a flow of air from the bottom toward the top of the bed. The relatively warm flow of air is added to the bottom layer of the manure pellets and is transported upwards through the pellets towards the upper level of the manure dryer. That means that the driest and firmest manure fraction will be on the bottom of the bed dryer 4. In order to release this dry fraction from the dryer bed 4, the trolley is provided with one or more impellers 181. as shown in reduced perspective in FIG. 4. Each impeller 80 is provided with a motor 81 to gently rotate a blade 82. The impeller 80 is also provided with means to move the blade 82 from a first position at a distance from the bottom of the bed dryer towards a second position closer to the bottom of the bed dryer. In this second position the blade 82 can be used to release the manure through the bottom of the bed dryer. Larger dry manure fractions will be broken into smaller elements by means of the blade. The dry manure elements, which are released from the dryer bed 4, have typically a minimum solids content of 85% and will therefore not be subject to the formation of fungi.

The drying process described above will be operated in a continuous mode. At regular intervals part of the dried manure will be released from the bottom of the bed dryer, while wet manure elements are added to the top of the bed dryer.

FIG. 5 shows a schematic cross section of an embodiment of the heat exchanger 8, which is shaped as a cooling tower. The cooling tower 8 is provided with a layer of packing material 35. A cooling medium 33, such as relatively cold water is fed to the packing material through lines 32. The lines may be provided with spray nozzles or holes, which similar as described with respect to the dust filter 5 allow the fluid to trickle, under the influence of gravity, down the packing material as a fluid film. At the bottom of the packing material the fluid drips into a liquid collector 36. Below the packing material 35, an inlet for air 37 is provided. This cooling tower is unlike regular cooling towers, where relatively warm cooling water is cooled by means of forced convection with ambient air. In the cooling tower 8 as used in embodiments of the manure dryer according to the present invention however, relatively cold water is used to extract heat from a relatively warm and saturated air flow. The relatively cold water is thereby heated and mixed with relatively warm condensed water.

Relatively warm and saturated air from the air washer 6 is fed through the line 58 to the inlet 37 and passed upward through the packing material 35. The relatively cold water 33 is added to the packing material as previously described and is heated to a temperature that very narrowly approaches the temperature of the relatively warm air flow as fed to the inlet 37. The warm fluid from the collector 36 may be temporarily stored in the heat buffer 20 or used directly in the heat exchanger 18 and partly in the heat exchanger 1 as previously described.

What is claimed is:

1. A method for drying a water containing substance, such as manure, into a single dry product, wherein an airflow is conditioned, in order for the airflow to be able to take up moisture, and wherein a substance/airflow interface is provided, in order to allow the air to take up moisture from the substance at the interface to thereby dry the substance, wherein the method comprising:
heating the airflow,
separating the substance into a relatively solid fraction and a liquid,
using the relatively solid fraction to create a first, static substance/airflow interface,
using the liquid fraction to create a second, dynamic substance/airflow interface,
guiding the airflow to the first substance/airflow interface to dry the relatively solid fraction of the water containing substance, and thereafter
guiding the airflow to the second substance/airflow interface to pre-dry the liquid fraction of the water containing substance,
mixing the pre-dried liquid fraction with water containing substance.

2. The method according to claim 1, comprising:
heating the airflow by means of low energy heat.

3. The method according to claim 2, comprising:
heating the airflow by guiding the airflow through an animal stable, in order to heat up the airflow by using heat produced by animals held in the stable.

4. The method according to claim 3, comprising:
further heating the airflow by guiding the airflow from the animal stable through a solar collector.

5. The method according to claim 2, comprising:
heating the airflow by guiding the airflow through a solar collector.

6. The method according to claim 1 comprising:
guiding the airflow, after drying the water containing substance by means of the airflow, via a closed conduit or line through an air washer for removing ammonia from the airflow before expelling the airflow to the environment.

7. The method according to claim 6, comprising:
guiding the airflow, after drying the water containing substance by means of the airflow and prior to guiding the airflow through an air washer, via a closed conduit or line through a neutralizer for neutralizing the residual acid in the wash water from the air washer with the ammonia in the airflow.

8. The method according to claim 7, comprising:
mixing the neutralized wash water from the neutralizer with water containing substance.

9. The method according to claim 1 comprising:
guiding the airflow, after drying the water containing substance by means of the airflow, via a closed conduit or line through a biological filter for removing odor from the airflow before expelling the airflow to the environment.

10. The method according to claim 1 comprising:
guiding the airflow, after drying the water containing substance by means of the airflow, via a closed conduit or line through a heat exchanger in order to remove residual heat from the airflow, before expelling the airflow to the environment.

11. The method according to claim 8, comprising:
pre-heating the airflow, prior to guiding the airflow through an animal stable, by heating one side of a heat conducting surface by means of a relatively warm fluid, such as water and using the other side of the heat conducting surface to pre-heat the airflow.

12. The method according to claim 1 comprising:
guiding part of the relatively solid fraction which has been dried in the first substance/airflow towards a mixer, for adding this dried portion to the relatively solid fraction leaving the separator, before guiding the so formed mixture of the relatively solid fraction and dried portion towards the first substance/airflow interface.

13. The method according to claim 1 comprising:
guiding the relatively solid fraction leaving the separator towards the first substance/airflow interface via a press in order to shape the relatively solid fraction in said press, and
drying the shaped relatively solid fraction in the first substance/airflow interface.

14. The method according to claim 1 comprising:
pre-heating the liquid fraction of the water containing substance, prior to guiding the liquid fraction towards the second substance/airflow interface, by heating one side of a heat conducting surface by means of a relatively warm fluid, such as water and using the other side of the heat conducting surface to pre-heat the liquid fraction of the water containing substance, in order to allow the pre-heated liquid fraction to heat up the airflow and at the same time allow the heated airflow to take up moisture from the liquid fraction.

15. The method according to claim 10 comprising:
removing residual heat from the airflow prior to expelling the airflow to the environment,
using the residual heat retrieved from the airflow to heat a fluid, such as water, and
using the heated fluid to pre-heat the liquid fraction of the water containing substance, prior to guiding the liquid fraction towards the second substance/airflow interface.

16. The method according to claim 10 comprising:
removing residual heat from the airflow prior to expelling the airflow to the environment,
using the residual heat retrieved from the airflow to heat a fluid, such as water, and
using the heated fluid to pre-heat the airflow, prior to guiding the airflow through an animal stable.

17. A system for drying a water containing substance, such as manure, comprising a ventilator for producing an airflow, air heating means, for conditioning the airflow, a substance/airflow interface, provided with a reservoir for containing the water containing substance and adapted to allow the conditioned airflow to pass through the reservoir in order to allow the air to take up moisture from the substance, the system comprising:
a separator for separating the water containing substance in a liquid fraction, essentially free of solid parts, and a relatively solid fraction,
a press for shaping the relatively solid fraction,
a first static substance/airflow interface, for drying the shaped relatively solid fraction of the water containing substance, and
a second dynamic substance/airflow interface, provided downstream from the first substance/airflow interface, to pre-dry the liquid fraction of the water containing substance.

18. The system according to claim 17, comprising:
a solar heat collector in order to heat the airflow by means of solar energy.

19. The system according to claim 17, comprising:
an air washer for removing ammonia from the airflow, provided downstream from the second substance/airflow interface and upstream from an exit for expelling the airflow to the environment.

20. The system according to claim 19, comprising:
a neutralizer for neutralizing residual acid in the wash water from the air washer with the ammonia in the airflow, provided downstream from the second substance/airflow interface and upstream from the air washer.

21. The system according to claim 17, comprising:
a biological filter for removing odor from the airflow, provided downstream from the second substance/airflow and upstream from an exit for expelling the airflow to the environment.

22. The system according to claim 17 comprising:
a heat exchanger in order to remove residual heat from the airflow, provided downstream from the second substance/airflow interface and upstream from an exit for expelling the airflow to the environment.

23. The system according to claim 22, comprising:
a direct contact heat exchanger such as an air cooler for directly heating a cold fluid such as water by means of a warm airflow.

24. The system according to claim 21, comprising:
a mixer, for mixing a dried portion of the water containing substance with the relatively solid fraction.

25. The system according to claim 22 comprising:
a plate heat exchanger, provided with one or more plates, wherein one of the interior or the exterior of the plates is connected with a line for transporting the liquid fraction and wherein the other is connected with a line for transporting a warm fluid, such as water, for indirectly heating the liquid fraction of the water containing substance by means of the warm fluid.
